(19) United States
(12) Patent Application Publication
(10) Pub. No.: US 2015/0204331 A1
(43) Pub. Date: Jul. 23, 2015

(54) METHOD FOR CONNECTING A COMPRESSOR WHEEL TO A SHAFT OF A SUPERCHARGING DEVICE

(71) Applicant: BorgWarner Inc., Auburn Hills, MI (US)

(72) Inventor: Dirk Ellenberger, Hochspeyer (DE)

(21) Appl. No.: 14/565,793

(22) Filed: Dec. 10, 2014

(30) Foreign Application Priority Data
Jan. 17, 2014 (DE) 10 2014 200 846.8
Jul. 14, 2014 (DE) 10 2014 213 641.5

(51) Int. Cl. F04C 29/00; B23K 20/00; B23K 20/02

(52) U.S. Cl. CPC F04C 29/0078; B23K 20/02; B23K 20/002

(57) ABSTRACT

A method for connecting a compressor wheel (2) to a shaft (3) of a supercharging device (1), having the following method steps: providing a compressor wheel (2), having a shaft-receiving recess (5) which has an inner diameter (DI); providing a (3), having a compressor-side shaft end (6) with an outer diameter (DA) which is at least equal to and preferably greater than the inner diameter (DI) of the shaft-receiving recess (5); and connecting the compressor wheel (2) to the compressor-side shaft end (6) by means of a cold-welding process (15) at the contact surfaces (8, 9) thereof.

### BACKGROUND OF THE INVENTION

1. Field of the Invention

The invention relates to a method for connecting a compressor wheel to a shaft of a supercharging device at the contact surfaces between compressor wheel and shaft.

2. Description of the Related Art

Changes in imbalance in hot operation of an exhaust-gas turbocharger are caused primarily by settling phenomena of the compressor wheel. Whereas the turbine wheel is permanently connected to the shaft of the rotor via a welding process, the compressor wheel sits more or less loosely on the shaft. In the prior art, interference fits, conical contact surfaces between adjoining components or optimized contact surfaces with increased friction coefficients are proposed for the purposes of reducing the movement of the compressor wheel on the shaft. Examples for this can be found in DE 10 2010 001 965 A1, WO 2010/111131 A2, DE 10 2008 053 222 A1 and DE 10 2008 061 167 A1.

The problem of the solutions proposed in the prior art can be seen primarily in the fact that they are technically cumbersome to implement and nevertheless, at least in part, do not permit adequate fixing of the compressor wheel on the shaft of the rotor.

It is therefore an object of the present invention to provide a method for connecting a compressor wheel to a shaft of a supercharging device, which method makes it possible for the compressor wheel to be seated in a permanently secure manner on the shaft.

### BRIEF SUMMARY OF THE INVENTION

The object is achieved by a method for connecting a compressor wheel to a shaft of a supercharging device, having the following method steps: providing a compressor wheel having a shaft-receiving recess which has an inner diameter (DI); providing a shaft having a compressor-side shaft end with an outer diameter (DA) which is at least equal to and preferably greater than the inner diameter (DI) of the shaft-receiving recess; and connecting the compressor wheel to the compressor-side shaft end via a cold-welding process at the contact surfaces thereof.

According to the invention, a permanent connection is realized between the contact surfaces of the compressor wheel and of the shaft by cold welding (also referred to colloquially as “seizing”). By the method according to the invention, translatory and/or rotary movements of the compressor wheel during operation are prevented entirely. According to the invention, the expression “cold welding” is to be understood as meaning the phenomenon whereby predominantly metallic workpieces of identical material can be connected to one another even at room temperature in such a way that the connection very closely resembles a normal weld.

To permit cold welding between the compressor wheel and the shaft end that bears the compressor wheel, the outer diameter of the shaft end is (in a manner corresponding to a transition fit) at least equal to the inner diameter of the recess, preferably greater than the inner diameter of the recess, of the compressor wheel that receives the shaft end.

Owing to a relative movement of the contact surfaces of the compressor wheel and of the shaft end under high pressure, the components are permanently connected at the atomic level during the cold-welding process.

Dependent claims relate to advantageous embodiments of the method according to the invention.

Accordingly, in a particularly preferred embodiment, the cold-welding process may be performed by virtue of the compressor wheel being pushed onto the shaft end as far as the sealing bushing, wherein a very high force has to be imparted.

In a further preferred embodiment, the compressor wheel may be heated such that it can be pushed onto the shaft end without resistance. As the compressor wheel cools, the latter or the rotor is set in rotation until the contact surfaces make contact and, in the process, are cold-welded.

Alternatively, it is basically also conceivable for the shaft end to be cooled such that it in turn can be pushed, without resistance, into the shaft receptacle of the compressor wheel, wherein the cold welding then occurs during a relative rotation between compressor wheel and shaft end as the shaft end warms up.

It is furthermore preferably possible for the contact surfaces to be provided with a predeterminable contour or waisted configuration, such that the cold welding is performed only at individual points.

The invention further concerns an exhaust-gas turbocharger rotor produced according to the method of the invention.

### BRIEF DESCRIPTION OF THE SEVERAL VIEWS OF THE DRAWINGS

Further details, features and advantages of the invention will emerge from the following description of exemplary embodiments on the basis of the drawing, in which:

FIG. 1 is a schematically slightly simplified illustration of a rotor according to the invention that has been produced in accordance with the principles of the method according to the invention; and

FIG. 2 is a schematically highly simplified illustration of an exhaust-gas turbocharger according to the invention that is equipped with the rotor according to the invention.

### DETAILED DESCRIPTION OF THE INVENTION

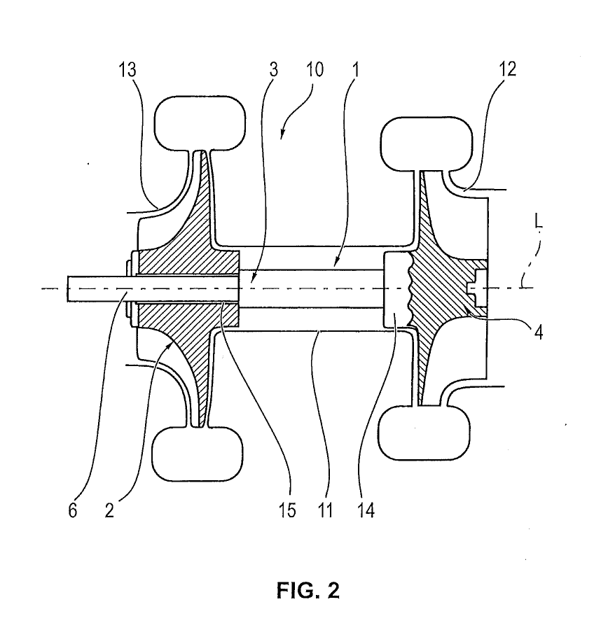

FIG. 2 illustrates, as an example for a supercharging device according to the invention, an exhaust-gas turbocharger 10 with a rotor 1 which comprises a compressor wheel 2, a shaft 3 and a turbine wheel 4. Here, the compressor wheel 2 is arranged on a compressor-wheel-side shaft end 6, whereas the turbine wheel 4 is arranged on a turbine-wheel-side shaft end 14.

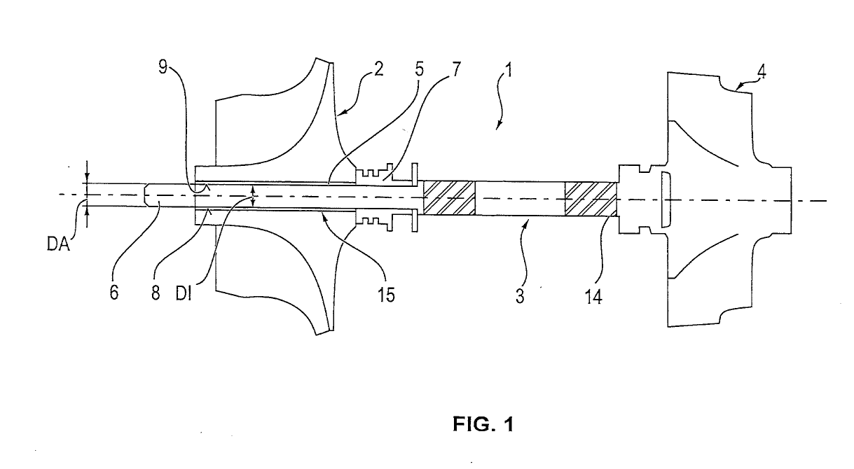

As has been explained in the introduction, the compressor wheel 2 is fixed to the shaft end 6 via a cold-welding process, as symbolised in FIG. 1 by the double line 15. For this purpose, in the particularly preferred embodiment that is illustrated, the outer diameter DA of the shaft end 6 is configured such that, before the cold-welding process is performed, the outer diameter is larger than the inner diameter DI of the shaft-receiving recess 5 of the compressor wheel 2. The resulting contact surfaces 8 of the shaft end 6 and 9 of the shaft-receiving recess 5 are brought into contact with one another as the compressor wheel 2 is pushed on or during the relative rotation, explained in the introduction, of the compressor wheel 2 relative to the shaft end 6, and during this “contacting” the contact surfaces are connected by way of the explained cold-welding process, which constitutes a connection at atomic level.

As is also shown in FIG. 1, the compressor wheel 2 is pushed onto the shaft end 6 as far as a sealing ring 7 arranged on the shaft 3.

The connection via the cold-welding process 5 very closely resembles a normal welded connection, which means in particular that the compressor wheel 2 can be dismounted from the shaft end 6 only by way of a destructive process. Since the compressor wheel 2 cannot move because it is welded to the shaft end 6, changes in imbalance are very greatly reduced and lie, merely owing to minor side effects, within the order of magnitude of the measurement accuracy of the balancing machine, as proven by tests carried out within the scope of the invention.

Furthermore, the method according to the invention yields the advantage that shaft nuts that have hitherto been used are no longer required, because it is no longer necessary for forces to be transmitted to the small parts of the shaft assembly or of the rotor 1. This means that the altogether highly cumbersome monitoring of the shaft nut mounting process as described in the prior art, such as pre-tightening, rotary angle final tightening or checking of the shaft elongation, are no longer required.

FIG. 2 shows the exhaust-gas turbocharger 10 according to the invention that is equipped with the rotor 1 according to the invention. Accordingly, the features that correspond to FIG. 1 are denoted by the same reference signs. Furthermore, FIG. 2 shows that the compressor wheel 2 is arranged in a compressor housing 13, the shaft 3 is mounted in a bearing housing 11, and the turbine wheel 14 is arranged in a turbine housing 12.

It is also pointed out that an electrical compressor or a supercharging blower may also constitute a supercharging device according to the invention.

To supplement the disclosure of the invention in addition to the written disclosure above, reference is hereby explicitly made to the diagrammatic illustration of the invention in FIGS. 1 and 2.

### LIST OF REFERENCE SIGNS

1 Exhaust-gas turbocharger rotor
2 Compressor wheel
3 Shaft
4 Turbine wheel
5 Shaft-receiving recess
6 Compressor-side shaft end
7 Sealing ring
8, 9 Contact surfaces
10 Exhaust-gas turbocharger
11 Bearing housing
12 Turbine housing
13 Compressor housing
14 Turbine-side shaft end
15 Cold weld
L Longitudinal axis of the turbocharger
DA Outer diameter of the shaft end 6
DI Inner diameter of the shaft-receiving recess 5

1. A method for connecting a compressor wheel (2) to a shaft (3) of a supercharging device (1), having the following method steps:
providing a compressor wheel (2), having a shaft-receiving recess (5) which has an inner diameter (DI);
providing a shaft (3) having a compressor-side shaft end (6) with an outer diameter (DA) which is at least equal to the inner diameter (DI) of the shaft-receiving recess (5); and
connecting the compressor wheel (2) to the compressor-side shaft end (6) via of a cold-welding process (15) at the contact surfaces (8, 9) thereof.

2. The method as claimed in claim 1, wherein the cold-welding process (15) is performed by virtue of the compressor wheel (2) being pushed onto the shaft end (6) as far as a sealing ring (7) that is arranged on the shaft (3).

3. The method as claimed in claim 1, wherein the compressor wheel (2) is heated and is pushed in the heated state onto the shaft end (6), and wherein, during the cooling of the compressor wheel (2), the compressor wheel (2) or the shaft (3) is rotated until the contact surfaces (8, 9) of the compressor wheel (2) and of the shaft end (6) make contact and, in the process, are cold-welded.

4. The method as claimed in claim 1, wherein the shaft end (6) is cooled and the compressor wheel (2) is pushed onto the shaft end (6) when the latter is in the cooled state, and wherein, during the heating of the shaft end (6), the latter or the compressor wheel (2) is rotated until the contact surfaces (8, 9) of the compressor wheel (2) and of the shaft end (6) make contact and, in the process, are cold-welded.

5. The method as claimed in claim 1, wherein at least one of the contact surfaces (8, 9) is provided with a predeterminable contour or waisted configuration.

6. A rotor of a supercharging device (1),
having a compressor wheel (2) which has a shaft-receiving recess (5) that comprises an inner diameter (DI); and
having a shaft (3) that has a compressor-side shaft end (6) with an outer diameter (DA),
wherein
the outer diameter (DA) of the shaft end (6) is at least equal to the inner diameter (DI) of the shaft-receiving recess.

7. The rotor as claimed in claim 6, wherein the shaft-receiving recess (5) and the shaft end (6) have contact surfaces (8, 9) that are provided with a predeterminable contour or waisted configuration.

8. The method as claimed in claim 1, wherein the shaft (3) has a compressor-side shaft end (6) with an outer diameter (DA) which is greater than the inner diameter (DI) of the shaft-receiving recess (5).

9. The rotor as claimed in claim 6, wherein the outer diameter (DA) of the shaft end (6) is greater than the inner diameter (DI) of the shaft-receiving recess.
